(19) United States
(12) Patent Application Publication
(10) Pub. No.: US 2025/0140860 A1
(43) Pub. Date: May 1, 2025

(54) NEGATIVE ELECTRODE SLURRY COMPOSITIONS FOR LITHIUM ION ELECTRICAL STORAGE DEVICES

(71) Applicant: PPG Industries Ohio, Inc., Cleveland, OH (US)

(72) Inventors: Fnu Gurudayal, Allison Park, PA (US); Scott William Sisco, Glenshaw, PA (US); Kevin Thomas Sylvester, Pittsburgh, PA (US)

(73) Assignee: PPG Industries Ohio, Inc., Cleveland, OH (US)

(21) Appl. No.: 18/681,259

(22) PCT Filed: Jun. 6, 2022
(86) PCT No.: PCT/US2022/072769

§ 371 Date: Feb. 5, 2024

Related U.S. Application Data
(60) Provisional application No. 63/230,231, filed on Aug. 6, 2021.

(51) Int. Cl. H01M 4/62; H01M 4/02; H01M 4/133; H01M 4/1393; H01M 4/36; H01M 4/38; H01M 4/583; H01M 10/0569; H01M 50/414

(52) U.S. Cl. CPC H01M 4/622; H01M 4/133; H01M 4/1393; H01M 4/364; H01M 4/386; H01M 4/583; H01M 4/625; H01M 10/0569; H01M 50/414; H01M 2004/027; H01M 2300/0051

(57) ABSTRACT

The present disclosure provides a negative electrode waterborne slurry composition comprising a binder comprising an addition polymer comprising (a) 0.1% to 15% by weight of constitutional units comprising the residue of an alpha, beta-ethylenically unsaturated carboxylic acid; (b) 0.1% to 25% by weight of constitutional units comprising the residue of an ethylenically unsaturated monomer comprising a hydroxyl functional group; (c) 30% to 90% by weight of constitutional units comprising the residue of an alkyl ester of (meth)acrylic acid; and (d) 0.1% to 50% by weight of constitutional units comprising the residue of a vinyl aromatic compound, the % by weight based on the total weight of the addition polymer; a negative electrode active material; and an aqueous medium. Also disclosed are slurry compositions and electrical storage devices.

### CROSS-REFERENCE TO RELATED APPLICATIONS

This application claims the benefit of U.S. Provisional Patent Application Ser. No. 63/230,231, filed on Aug. 6, 2021, which is incorporated herein by reference.

### NOTICE OF GOVERNMENT SUPPORT

This disclosure was made with Government support under Government Contract No. DE-EE0006250 awarded by the Department of Energy. The United States Government has certain rights in this disclosure.

### FIELD

The disclosure relates to slurry compositions that could be used in manufacturing negative electrodes for use in electrical storage devices, such as batteries.

### BACKGROUND

There is a trend in the electronics industry to produce smaller devices, powered by smaller and lighter batteries. Batteries with a negative electrode—such as a carbonaceous material, and a positive electrode—such as lithium metal oxides can provide relatively high power and low weight; however, a negative electrode active layer expands and contracts during charging and discharging. As a result, there is a problem in that the electron conductivity between negative active materials may change and increase the conductive path between a negative active material and a current collector, and thus cycle characteristics of a rechargeable battery may be deteriorated. In addition, typical negative electrode binders cannot form thick active layer coatings because the coatings are brittle and suffer from cracks or other defects. An improved electrode is desired.

### SUMMARY

The present disclosure provides a negative electrode waterborne slurry composition comprising a binder comprising an addition polymer comprising (a) 0.1% to 15% by weight of constitutional units comprising the residue of an alpha, beta-ethylenically unsaturated carboxylic acid; (b) 0.1% to 25% by weight of constitutional units comprising the residue of an ethylenically unsaturated monomer comprising a hydroxyl functional group; (c) 30% to 90% by weight of constitutional units comprising the residue of an alkyl ester of (meth)acrylic acid; and (d) 0.1% to 50% by weight of constitutional units comprising the residue of a vinyl aromatic compound, the % by weight based on the total weight of the addition polymer; a negative electrode active material; and an aqueous medium.

The present disclosure also provides a negative electrode comprising (a) an electrical current collector; and (b) a film formed on the electrical current collector, wherein the film comprises (1) a binder comprising an addition polymer comprising: (i) 0.1% to 15% by weight of constitutional units comprising the residue of an alpha, beta-ethylenically unsaturated carboxylic acid; (ii) 0.1% to 25% by weight of constitutional units comprising the residue of an ethylenically unsaturated monomer comprising a hydroxyl functional group; (iii) 30% to 90% by weight of constitutional units comprising the residue of an alkyl ester of (meth)acrylic acid; and (iv) 0.1% to 50% by weight of constitutional units comprising the residue of a vinyl aromatic compound, the % by weight based on the total weight of the addition polymer; and (2) a negative electrode active material.

The present disclosure further provides an electrical storage device comprising (a) a negative electrode comprising an electrical current collector; and a film formed on the electrical current collector, wherein the film comprises (1) a binder comprising an addition polymer comprising: (i) 0.1% to 15% by weight of constitutional units comprising the residue of an alpha, beta-ethylenically unsaturated carboxylic acid; (ii) 0.1% to 25% by weight of constitutional units comprising the residue of an ethylenically unsaturated monomer comprising a hydroxyl functional group; (iii) 30% to 90% by weight of constitutional units comprising the residue of an alkyl ester of (meth)acrylic acid; and (iv) 0.1% to 50% by weight of constitutional units comprising the residue of a vinyl aromatic compound, the % by weight based on the total weight of the addition polymer; and (2) a negative electrode active material; (b) a positive electrode; (c) an electrolyte; and (d) a polymer separator.

### DETAILED DESCRIPTION

The present disclosure is directed to a negative electrode waterborne slurry composition comprising a binder comprising an addition polymer comprising (a) 0.1% to 15% by weight of constitutional units comprising the residue of an alpha, beta-ethylenically unsaturated carboxylic acid; (b) 0.1% to 25% by weight of constitutional units comprising the residue of an ethylenically unsaturated monomer comprising constitutional units comprising the residue of a hydroxyl functional group; (c) 30% to 90% by weight of an alkyl ester of (meth)acrylic acid; and (d) 0.1% to 50% by weight of constitutional units comprising the residue of a vinyl aromatic compound, the % by weight based on the total weight of the addition polymer; a negative electrode active material; and an aqueous medium.

The slurry composition of the present disclosure comprises an addition polymer. The addition polymer comprises constitutional units comprising the residue of unsaturated monomers. The addition polymer may be in the form of a block polymer, a random polymer, or a gradient polymer.

The addition polymer may comprise constitutional units comprising the residue of an alpha, beta-ethylenically unsaturated carboxylic acid. Non-limiting examples of alpha, beta-ethylenically unsaturated carboxylic acids include those containing up to 10 carbon atoms such as acrylic acid and methacrylic acid. Non-limiting examples of other unsaturated acids are alpha, beta-ethylenically unsaturated dicarboxylic acids such as maleic acid or its anhydride, fumaric acid and itaconic acid. Also, the half esters of these dicarboxylic acids may be employed. The constitutional units comprising the residue of the alpha, beta-ethylenically unsaturated carboxylic acids may comprise at least 0.1% by weight, such as at least 0.5% by weight, such as at least 1% by weight, such as at least 1.5% by weight, such as at least 3% by weight, such as at least 5% by weight, based on the total weight of the addition polymer. The constitutional units comprising the residue of the alpha, beta-ethylenically unsaturated carboxylic acids may comprise no more than 15% by weight, such as no more than 10% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the addition polymer. The constitutional units comprising the residue of the alpha, beta-ethylenically unsaturated carboxylic acids may comprise 0.1% to 15% by weight, such as 0.1% to 10% by weight, such as 0.1% to 8% by weight, such as 0.1% to 6% by weight, such as 0.1% by to 5% by weight, such as 0.1% to 4% by weight, such as 0.5% to 3% by weight, such as 0.1% to 2% by weight, such as 0.1% to 1.5% by weight, such as 0.1% to 1.0% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, such as 3% to 15% by weight, such as 3% to 10% by weight, such as 3% to 8% by weight, such as 3% to 6% by weight, such as 3% by to 5% by weight, such as 3% to 4% by weight, such as 5% to 15% by weight, such as 5% to 10% by weight, such as 5% to 8% by weight, such as 5% to 6% by weight, based on the total weight of the addition polymer. The addition polymer may be derived from a reaction mixture comprising the alpha, beta-ethylenically unsaturated carboxylic acids in an amount of 0.1% to 15% by weight, such as 0.1% to 10% by weight, such as 0.1% to 8% by weight, such as 0.1% to 6% by weight, such as 0.1% by to 5% by weight, such as 0.1% to 4% by weight, such as 0.5% to 3% by weight, such as 0.1% to 2% by weight, such as 0.1% to 1.5% by weight, such as 0.1% to 1.0% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, such as 3% to 15% by weight, such as 3% to 10% by weight, such as 3% to 8% by weight, such as 3% to 6% by weight, such as 3% by to 5% by weight, such as 3% to 4% by weight, such as 5% to 15% by weight, such as 5% to 10% by weight, such as 5% to 8% by weight, such as 5% to 6% by weight, based on the total weight of polymerizable monomers used in the reaction mixture. The inclusion of constitutional units comprising the residue of an alpha, beta-ethylenically unsaturated carboxylic acids in the addition polymer results in an addition polymer comprising at least one carboxylic acid group. Carboxylic acid groups resulting from inclusion of the alpha, beta-ethylenically unsaturated carboxylic acids may react with a separately added crosslinking agent that comprises functional groups reactive with carboxylic acid groups such as, for example, carbodiimides, polyepoxides, polyoxazolines, and polyaziridines.

The addition polymer may comprise constitutional units comprising the residue of an ethylenically unsaturated monomer comprising a hydroxyl functional group. Non-limiting examples of ethylenically unsaturated monomer comprising a hydroxyl functional group include hydroxyalkyl esters such as hydroxyethyl (meth)acrylate, hydroxypropyl (meth)acrylate, and hydroxybutyl (meth)acrylate. The constitutional units comprising the residue of an ethylenically unsaturated monomer comprising a hydroxyl functional group may comprise at least 0.1% by weight, such as at least 0.5% by weight, such as at least 1% by weight, such as at least 1.5% by weight, such as at least 3% by weight, such as at least 5% by weight, such as at least 7% by weight, such as at least 8% by weight, based on the total weight of the addition polymer. The constitutional units comprising the residue of an ethylenically unsaturated monomer comprising a hydroxyl functional group may comprise no more than 25% by weight, such as no more than 20% by weight, such as no more than 15% by weight, such as no more than 10% by weight, such as no more than 8% by weight, such as no more than 6% by weight, such as no more than 5% by weight, such as no more than 3% by weight, such as no more than 2% by weight, such as no more than 1% by weight, based on the total weight of the addition polymer. The constitutional units comprising the residue of an ethylenically unsaturated monomer comprising a hydroxyl functional group may comprise 0.1% to 25% by weight, such as 0.1% to 20% by weight, such as 0.1% to 15% by weight, such as 0.1% to 10% by weight, such as 0.1% to 8% by weight, such as 0.1% to 6% by weight, such as 0.1% by to 5% by weight, such as 0.1% to 3% by weight, such as 0.1% to 2% by weight, such as 0.1% to 1% by weight, 0.5% to 25% by weight, such as 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 3% by weight, such as 0.5% to 2% by weight, such as 0.5% to 1% by weight, such as 1% to 25% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 3% by weight, such as 1% to 2% by weight, such as 1.5% to 25% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 3% by weight, such as 1.5% to 2% by weight, such as 3% to 25% by weight, such as 3% to 20% by weight, such as 3% to 15% by weight, such as 3% to 10% by weight, such as 3% to 8% by weight, such as 3% to 6% by weight, such as 3% by to 5% by weight, such as 5% to 25% by weight, such as 5% to 20% by weight, such as 5% to 15% by weight, such as 5% to 10% by weight, such as 5% to 8% by weight, such as 5% to 6% by weight, such as 7% to 25% by weight, such as 7% to 20% by weight, such as 7% to 15% by weight, such as 7% to 10% by weight, such as 7% to 8% by weight, such as 8% to 25% by weight, such as 8% to 20% by weight, such as 8% to 15% by weight, such as 8% to 10% by weight, based on the total weight of the addition polymer. The addition polymer may be derived from a reaction mixture comprising the hydroxyalkyl ester in an amount of 0.1% to 25% by weight, such as 0.1% to 20% by weight, such as 0.1% to 15% by weight, such as 0.1% to 10% by weight, such as 0.1% to 8% by weight, such as 0.1% to 6% by weight, such as 0.1% by to 5% by weight, such as 0.1% to 3% by weight, such as 0.1% to 2% by weight, such as 0.1% to 1% by weight, 0.5% to 25% by weight, such as 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 3% by weight, such as 0.5% to 2% by weight, such as 0.5% to 1% by weight, such as 1% to 25% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 3% by weight, such as 1% to 2% by weight, such as 1.5% to 25% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 3% by weight, such as 1.5% to 2% by weight, such as 3% to 25% by weight, such as 3% to 20% by weight, such as 3% to 15% by weight, such as 3% to 10% by weight, such as 3% to 8% by weight, such as 3% to 6% by weight, such as 3% by to 5% by weight, such as 5% to 25% by weight, such as 5% to 20% by weight, such as 5% to 15% by weight, such as 5% to 10% by weight, such as 5% to 8% by weight, such as 5% to 6% by weight, such as 7% to 25% by weight, such as 7% to 20% by weight, such as 7% to 15% by weight, such as 7% to 10% by weight, such as 7% to 8% by weight, such as 8% to 25% by weight, such as 8% to 20% by weight, such as 8% to 15% by weight, such as 8% to 10% by weight, based on the total weight of polymerizable monomers used in the reaction mixture. The inclusion of constitutional units comprising the residue of a hydroxyalkyl ester in the addition polymer results in an addition polymer comprising at least one hydroxyl group (although hydroxyl groups may be included by other methods). Hydroxyl groups resulting from inclusion of the hydroxyalkyl esters (or incorporated by other means) may react with a separately added crosslinking agent that comprises functional groups reactive with hydroxyl groups such as, for example, an aminoplast, phenolplast, polyepoxides that have groups that are reactive with the hydroxyl groups are incorporated into the addition polymer.

The additional polymer may further comprise constitutional units comprising the residue of an alkyl ester of (meth)acrylic acid. The alkyl ester of (meth)acrylic acid may comprise from 1 to 18 carbon atoms in the alkyl group. Non-limiting examples of alkyl esters of (meth)acrylic acid include methyl (meth)acrylate, ethyl (meth)acrylate, propyl (meth)acrylate, butyl (meth)acrylate, hexyl (meth)acrylate, octyl (meth)acrylate, isodecyl (meth)acrylate, stearyl (meth)acrylate, 2-ethylhexyl (meth)acrylate, decyl (meth)acrylate, and dodecyl (meth)acrylate, as well as alkyl ester of (meth)acrylic acids having cycloaliphatic groups, such as cyclohexyl (meth)acrylate, isobornyl (meth)acrylate, and others. The constitutional units comprising the residue of the alkyl esters of (meth)acrylic acid may comprise at least 30% by weight, such as at least 35% by weight, such as at least 40% by weight, such as at least 45% by weight, such as at least 50% by weight, such as at least 55% by weight, such as at least 60% by weight, based on the total weight of the addition polymer. The constitutional units comprising the residue of the alkyl esters of (meth)acrylic acid may comprise no more than 90%, such as no more than 85%, such as no more than 80%, such as no more than 75%, such as no more than 70%, such as no more than 65%, such as no more than 60% by weight, based on the total weight of the addition polymer. The constitutional units comprising the residue of the alkyl esters of (meth)acrylic acid may comprise such as 30% to 90% by weight, such as 30% to 85% by weight, such as 30% to 80% by weight, such as 30% to 75% by weight, such as 30% to 70% by weight, such as 30% to 65% by weight, such as 30% to 60% by weight, such as 35% to 90% by weight, such as 35% to 85% by weight, such as 35% to 80% by weight, such as 35% to 75% by weight, such as 35% to 70% by weight, such as 35% to 65% by weight, such as 35% to 60% by weight, such as 40% to 90% by weight, such as 40% to 85% by weight, such as 40% to 80% by weight, such as 40% to 75% by weight, such as 40% to 70% by weight, such as 40% to 65% by weight, such as 40% to 60% by weight, such as 45% to 90% by weight, such as 45% to 85% by weight, such as 45% to 80% by weight, such as 45% to 75% by weight, such as 45% to 70% by weight, such as 45% to 65% by weight, such as 45% to 60% by weight, such as 50% to 90% by weight, such as 50% to 85% by weight, such as 50% to 80% by weight, such as 50% to 75% by weight, such as 50% to 70% by weight, such as 50% to 65% by weight, such as 50% to 60% by weight, such as 55% to 90% by weight, such as 55% to 85% by weight, such as 55% to 80% by weight, such as 55% to 75% by weight, such as 55% to 70% by weight, such as 55% to 65% by weight, such as 55% to 60% by weight, such as 60% to 90% by weight, such as 60% to 85% by weight, such as 60% to 80% by weight, such as 60% to 75% by weight, such as 60% to 70% by weight, such as 60% to 65% by weight, based on the total weight of the addition polymer. The addition polymer may be derived from a reaction mixture comprising the alkyl esters of (meth)acrylic acid in an amount of 30% to 90% by weight, such as 30% to 85% by weight, such as 30% to 80% by weight, such as 30% to 75% by weight, such as 30% to 70% by weight, such as 30% to 65% by weight, such as 30% to 60% by weight, such as 35% to 90% by weight, such as 35% to 85% by weight, such as 35% to 80% by weight, such as 35% to 75% by weight, such as 35% to 70% by weight, such as 35% to 65% by weight, such as 35% to 60% by weight, such as 40% to 90% by weight, such as 40% to 85% by weight, such as 40% to 80% by weight, such as 40% to 75% by weight, such as 40% to 70% by weight, such as 40% to 65% by weight, such as 40% to 60% by weight, such as 45% to 90% by weight, such as 45% to 85% by weight, such as 45% to 80% by weight, such as 45% to 75% by weight, such as 45% to 70% by weight, such as 45% to 65% by weight, such as 45% to 60% by weight, such as 50% to 90% by weight, such as 50% to 85% by weight, such as 50% to 80% by weight, such as 50% to 75% by weight, such as 50% to 70% by weight, such as 50% to 65% by weight, such as 50% to 60% by weight, such as 55% to 90% by weight, such as 55% to 85% by weight, such as 55% to 80% by weight, such as 55% to 75% by weight, such as 55% to 70% by weight, such as 55% to 65% by weight, such as 55% to 60% by weight, such as 60% to 90% by weight, such as 60% to 85% by weight, such as 60% to 80% by weight, such as 60% to 75% by weight, such as 60% to 70% by weight, such as 60% to 65% by weight, based on the total weight of polymerizable monomers used in the reaction mixture.

The addition polymer may further comprise constitutional units comprising the residue of a vinyl aromatic compound. Non-limiting examples of vinyl aromatic compounds includes styrene, alpha-methyl styrene, alpha-chlorostyrene, and vinyl toluene. The constitutional units comprising the residue of the vinyl aromatic compound may comprise at least 0.1% by weight, such as at least 1% by weight, such as at least 5% by weight, such as at least 10% by weight, such as at least 15% by weight, such as at least 20% by weight, such as at least 25% by weight, based on the total weight of the addition polymer. The constitutional units comprising the residue of the vinyl aromatic compound may comprise no more than 50% by weight, such as no more than 40% by weight, such as no more than 30% by weight, such as no more than 20% by weight, such as no more than 15% by weight, such as no more than 10% by weight, based on the total weight of the addition polymer. The constitutional units comprising the residue of the vinyl aromatic compound may comprise such as 0.1% to 50% by weight, such as 0.1% to 40% by weight, such as 0.1% to 30% by weight, such as 0.1% to 20% by weight, such as 0.1% to 15% by weight, such as 0.1% to 10% by weight, such as 1% to 50% by weight, such as 1% to 40% by weight, such as 1% to 30% by weight, such as 1% to 20% by weight, such as 1% to 15% by weight, such as 1% to 10% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 50% by weight, such as 10% to 40% by weight, such as 10% to 30% by weight, such as 10% to 20% by weight, such as 10% to 15% by weight, such as 15% to 50% by weight, such as 15% to 40% by weight, such as 15% to 30% by weight, such as 15% to 20% by weight, such as 20% to 50% by weight, such as 20% to 40% by weight, such as 20% to 30% by weight, such as 25% to 50% by weight, such as 25% to 40% by weight, such as 25% to 30% by weight, based on the total weight of the addition polymer. The addition polymer may be derived from a reaction mixture comprising the vinyl aromatic compound in an amount of such as 0.1% to 50% by weight, such as 0.1% to 40% by weight, such as 0.1% to 30% by weight, such as 0.1% to 20% by weight, such as 0.1% to 15% by weight, such as 0.1% to 10% by weight, such as 1% to 50% by weight, such as 1% to 40% by weight, such as 1% to 30% by weight, such as 1% to 20% by weight, such as 1% to 15% by weight, such as 1% to 10% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 50% by weight, such as 10% to 40% by weight, such as 10% to 30% by weight, such as 10% to 20% by weight, such as 10% to 15% by weight, such as 15% to 50% by weight, such as 15% to 40% by weight, such as 15% to 30% by weight, such as 15% to 20% by weight, such as 20% to 50% by weight, such as 20% to 40% by weight, such as 20% to 30% by weight, such as 25% to 50% by weight, such as 25% to 40% by weight, such as 25% to 30% by weight, based on the total weight of polymerizable monomers used in the reaction mixture.

The addition polymer may optionally further comprise constitutional units comprising the residue of a methoxy(poly(alkyleneglycol)) (meth)acrylate. Non-limiting examples of methoxy(poly(alkyleneglycol)) (meth)acrylates include methoxy(poly(ethyleneglycol)) (meth)acrylate and methoxy(poly(propyleneglycol)) (meth)acrylate. If present, the constitutional units comprising the residue of the methoxy(poly(alkyleneglycol)) (meth)acrylate may comprise at least 0.1% by weight, such as at least 0.5% by weight, such as at least 1% by weight, such as at least 1.5% by weight, such as at least 3% by weight, such as at least 5% by weight, based on the total weight of the addition polymer. If present, the constitutional units comprising the residue of the methoxy(poly(alkyleneglycol)) (meth)acrylate may comprise no more than 10% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight, based on the total weight of the addition polymer. The constitutional units comprising the residue of the methoxy(poly(alkyleneglycol)) (meth)acrylate may comprise 0.1% to 10% by weight, such as 0.1% to 8% by weight, such as 0.1% to 6% by weight, such as 0.1% by to 5% by weight, such as 0.1% to 4% by weight, such as 0.5% to 3% by weight, such as 0.1% to 2% by weight, such as 0.1% to 1.5% by weight, such as 0.1% to 1.0% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, such as 3% to 10% by weight, such as 3% to 8% by weight, such as 3% to 6% by weight, such as 3% by to 5% by weight, such as 3% to 4% by weight, such as 5% to 10% by weight, such as 5% to 8% by weight, such as 5% to 6% by weight, based on the total weight of the addition polymer. The addition polymer may be derived from a reaction mixture comprising the methoxy(poly(alkyleneglycol)) (meth)acrylate in an amount of 0.1% to 10% by weight, such as 0.1% to 8% by weight, such as 0.1% to 6% by weight, such as 0.1% by to 5% by weight, such as 0.1% to 4% by weight, such as 0.5% to 3% by weight, such as 0.1% to 2% by weight, such as 0.1% to 1.5% by weight, such as 0.1% to 1.0% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, such as 3% to 10% by weight, such as 3% to 8% by weight, such as 3% to 6% by weight, such as 3% by to 5% by weight, such as 3% to 4% by weight, such as 5% to 10% by weight, such as 5% to 8% by weight, such as 5% to 6% by weight, based on the total weight of polymerizable monomers used in the reaction mixture.

The addition polymer may optionally comprise constitutional units comprising the residue of other alpha, beta-ethylenically unsaturated monomers. Non-limiting examples of other alpha, beta-ethylenically unsaturated monomers include organic nitriles such as acrylonitrile and methacrylonitrile; allyl monomers such as allyl chloride and allyl cyanide; monomeric dienes such as 1,3-butadiene and 2-methyl-1,3-butadiene; acetoacetoxyalkyl (meth)acrylates such as acetoacetoxyethyl methacrylate (AAEM) (which may be self-crosslinking); difunctional unsaturated monomers such as ethyleneglycol dimethacrylate, hexanediol diacrylate; vinyl esters such as vinyl acetate; N-vinyl amides and N-vinyl lactams such as N-vinyl acetamide and N-vinyl pyrrolidone; (meth)acrylamides such as acrylamide, N-butoxymethylol acrylamide, N-methylol acrylamide, isopropyl acrylamide, and diacetone acrylamide. The constitutional units comprising the residue of the other alpha, beta-ethylenically unsaturated monomers may comprise at least at least 0.5% by weight, such as at least 1% by weight, such as at least 1.5% by weight, based on the total weight of the addition polymer. The constitutional units comprising the residue of the other alpha, beta-ethylenically unsaturated monomers may comprise 20% by weight, such as no more than 15% by weight, such as no more than 8% by weight, such as no more than 6% by weight, such as no more than 5% by weight, such as no more than 4% by weight, such as no more than 3% by weight, such as no more than 2% by weight, such as no more than 1.5% by weight, such as no more than 1.0% by weight. based on the total weight of the addition polymer. The constitutional units comprising the residue of the other alpha, beta-ethylenically unsaturated monomers may comprise 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of the addition polymer. The addition polymer may be derived from a reaction mixture comprising the other alpha, beta-ethylenically unsaturated monomers in an amount of 0.5% to 20% by weight, such as 0.5% to 15% by weight, such as 0.5% to 10% by weight, such as 0.5% to 8% by weight, such as 0.5% to 6% by weight, such as 0.5% by to 5% by weight, such as 0.5% to 4% by weight, such as 0.5% to 3% by weight, such as 0.5% to 2% by weight, such as 0.5% to 1.5% by weight, such as 0.5% to 1.0% by weight, such as 1% to 20% by weight, such as 1% to 15% by weight, such as 1% to 10% by weight, such as 1% to 8% by weight, such as 1% to 6% by weight, such as 1% by to 5% by weight, such as 1% to 4% by weight, such as 1% to 3% by weight, such as 1% to 2% by weight, such as 1% to 1.5% by weight, such as 1.5% to 20% by weight, such as 1.5% to 15% by weight, such as 1.5% to 10% by weight, such as 1.5% to 8% by weight, such as 1.5% to 6% by weight, such as 1.5% by to 5% by weight, such as 1.5% to 4% by weight, such as 1.5% to 3% by weight, such as 1.5% to 2% by weight, based on the total weight of polymerizable monomers used in the reaction mixture.

The monomers and relative amounts may be selected such that the resulting addition polymer has a Tg of 50° C. or less. The resulting (meth)acrylic polymer may have a Tg of, for example, at least −50° C., such as at least −40° C., such as −30° C., such as, −20° C., such as −15° C., such as −10° C., such as −5° C., such as 0° C. The resulting (meth)acrylic polymer may have a Tg of, for example, such as no more than +50° C., such as no more than +40° C., such as no more than +25° C., such as no more than +15° C., such as no more than +10° C., such as no more than +5° C., such as no more than 0° C. The resulting (meth)acrylic polymer may have a Tg of, for example, such as −50 to +50° C., such as −50 to +40° C., such as −50 to +25° C., such as −50 to +20° C., such as −50 to +15° C., such as −50 to +10° C., such as −50 to +5° C., such as −50 to 0° C., such as −40 to +50° C., such as −40 to +40° C., such as −40 to +25° C., such as −40 to +20° C., such as −40 to +15° C., such as −40 to +10° C., such as −40 to +5° C., such as −40 to 0° C., such as −30 to +50° C., such as −30 to +40° C., such as −30 to +25° C., such as −30 to +20° C., such as −30 to +15° C., such as −30 to +10° C., such as −30 to +5° C., such as −30 to 0° C., such as −20 to +50° C., such as −20 to +40° C., such as −20 to +25° C., such as −20 to +20° C., such as −20 to +15° C., such as −20 to +10° C., such as −20 to +5° C., such as −20 to 0° C., such as −15 to +50° C., such as −15 to +40° C. such as −15 to +25° C., such as −15 to +20° C., such as −15 to +15° C., such as −15 to +10° C., such as −15 to +5° C., such as −15 to 0° C., such as −10 to +50° C., such as −10 to +40° C., such as −10 to +25° C., such as −10 to +20° C., such as −10 to +15° C., such as −10 to +10° C., such as −10 to +5° C., such as −10 to 0° C., such as −5 to +50° C., such as −5 to +40° C., such as −5 to +25° C., such as −5 to +20° C., such as −5 to +15° C., such as −5 to +10° C., such as −5 to +5° C., such as −5 to 0° C., such as 0 to +50° C., such as 0 to +40° C., such as 0 to +25° C., such as 0 to +20° C., such as 0 to +15° C. A lower Tg that is below 0° C. may be desirable to ensure acceptable battery performance at low temperature.

The addition polymer may have a weight average molecular weight of at least at least 5,000 g/mol, such as at least 20,000 g/mol, such as at least 50,000 g/mol, such as at least 75,000 g/mol, such as at least 95,000 g/mol. The addition polymer may have a weight average molecular weight of no more than 1,000,000 g/mol, such as no more than 500,000 g/mol, such as no more than 200,000 g/mol, such as no more than 150,000 g/mol, such as no more than 100,000 g/mol. The addition polymer may have a weight average molecular weight of 5,000 to 1,000,000 g/mol, such as 5,000 to 500,000 g/mol, such as 5,000 to 200,000 g/mol, such as 5,000 to 150,000 g/mol, such as 5,000 to 100,000 g/mol, such as 20,000 to 1,000,000 g/mol, such as 20,000 to 500,000 g/mol, such as 20,000 to 200,000 g/mol, such as 20,000 to 150,000 g/mol, such as 20,000 to 100,000 g/mol, such as 50,000 to 1,000,000 g/mol, such as 50,000 to 500,000 g/mol, such as 50,000 to 200,000 g/mol, such as 50,000 to 150,000 g/mol, such as 50,000 to 100,000 g/mol, such as 75,000 to 1,000,000 g/mol, such as 75,000 to 500,000 g/mol, such as 75,000 to 200,000 g/mol, such as 75,000 to 150,000 g/mol, such as 75,000 to 100,000 g/mol, such as 95,000 to 1,000,000 g/mol, such as 95,000 to 500,000 g/mol, such as 95,000 to 200,000 g/mol, such as 95,000 to 150,000 g/mol, such as 95,000 to 100,000 g/mol.

The addition polymers may be prepared by conventional free radical initiated solution polymerization techniques in which the polymerizable monomers are dissolved in an organic medium comprising a solvent or a mixture of solvents and polymerized in the presence of a free radical initiator until conversion is complete.

Examples of free radical initiators are those which are soluble in the organic medium such as azobisisobutyronitrile, azobis(alpha, gamma-methylvaleronitrile), tertiary-butyl perbenzoate, tertiary-butyl peracetate, benzoyl peroxide, ditertiary-butyl peroxide and tertiary amyl peroxy 2-ethylhexyl carbonate.

Optionally, a chain transfer agent which is soluble in the mixture of monomers such as alkyl mercaptans, for example, tertiary-dodecyl mercaptan; ketones such as methyl ethyl ketone, chlorohydrocarbons such as chloroform can be used. A chain transfer agent provides control over the molecular weight to give products having required viscosity for various coating applications.

To prepare the addition polymer, the solvent may be first heated to reflux and then a mixture of polymerizable monomers and a mixture of free radical initiator in an organic medium may be separately added to the refluxing solvent over a period of time. The reaction mixture is then held at polymerizing temperatures so as to reduce the free monomer content, such as to below 1.0 percent and usually below 0.5 percent, based on the total weight of the mixture of polymerizable monomers.

Following polymerization in the organic medium and prior to dispersion in an aqueous medium, the carboxylic acid groups of the addition polymer, if present, may be at least partially neutralized by contacting said addition polymer with a neutralizing base. Examples of suitable neutralizing bases include, but are not limited to tertiary amines such as, for example, dimethylethanolamine (DMEA), trimethyl amine, methyl diethanol amine, ethyl methyl ethanol amine, dimethyl ethyl amine, dimethyl propyl amine, dimethyl 3-hydroxy-1-propyl amine, dimethylbenzyl amine, dimethyl 2-hydroxy-1-propyl amine, diethyl methyl amine, dimethyl 1-hydroxy-2-propyl amine, triethyl amine, tributyl amine, N-methyl morpholine; ammonia; hydrazine; metallic aluminium; metallic zinc; water-soluble oxides of the elements Li, Na, K, Mg, Ca, Fe(II) and Sn(II); water-soluble hydroxides of the elements Li, Na, K, Mg, Ca, Fe(II) and Sn(II); water-soluble carbonates of the elements Li, Na, K, Mg, Ca, Fe(II) and Sn(II); and combinations thereof. The neutralizing base may comprise a tertiary amine. The neutralizing base may comprise dimethylethanolamine (DMEA).

The solution polymerized addition polymer may be substantially dissolved and/or dispersed in water before, during or after the addition of neutralizing base. The solution polymerized addition polymer may be substantially dissolved and/or dispersed in water during the addition of neutralizing base. Therefore, the solution polymerized addition polymer may be formed in a solvent and subsequently substantially dissolved and/or dispersed in water. The solution polymerized addition polymer may have sufficient functionality such that it may be substantially dissolved in water.

The addition polymer may also be prepared by conventional emulsion polymerization techniques. The addition polymer can be prepared by conventional emulsion batch process or a continuous process. In one example of a batch process, the monomer composition is fed over a period of 1 hour to 4 hours into a heated reactor initially charged with water. The initiator can be fed in simultaneously, it can be part of the monomer composition or it can be charged to the reactor before feeding in the monomer composition. The optimum temperature depends upon the specific initiator being used. The length of time may range from 2 hours to 6 hours, and the temperature of reaction may range from 25° C. to 90° C.

In another example, water and a small portion of the monomer composition may be charged to a reactor with a small amount of surfactant and free radical initiator to form a seed. A preemulsion of the remaining monomers, surfactant and water are fed along with the initiator over a prescribed period of time (e.g., 3 hours) at a reaction temperature of about 80° C. to 85° C. using a nitrogen blanket. After a one-hour hold, upon completion of the monomer feed, a post redox feed to reduce residual free monomer (including hydrogen peroxide/isoascorbic acid) is added to the reactor. The latex product is then neutralized to a pH of 7 to 8.

The emulsion polymerization reaction mixture may comprise a surfactant. The surfactant may be an anionic, cationic, or non-ionic type stabilizer. Suitable examples of anionic surfactants include, but are not limited to, alkyl sulphates such as, for example, sodium dodecyl sulphate or sodium polyoxy ethylene alkyl ether sulphate; aryl sulphonates such as, for example, sodium dodecylbenzene sulphonate; sulphosuccinates such as, for example, sodium diisobutyl sulpho succinate, sodium dioctyl sulpho succinate and sodium di cyclohexyl sulpho succinate; and combinations thereof. Suitable examples of nonionic emulsifiers include, but are not limited to, fatty alcohol ethoxylates such as, for example polyethylene glycol mono lauryl ether; fatty acid ethoxylates such as, for example, polyethylene glycol mono stearate or polyethylene glycol mono laurate; polyether block polymers such as, for example, polyethylene glycol/polypropylene glycol block polymers also known as pluronics, commercial products of this type include Tergitol® XJ, XH or XD commercially available from Dow Chemical; and combinations thereof. Suitable examples of cationic emulsifiers include, but are not limited to, amine salts such as, for example, cetyl trimethyl ammonium chloride or benzyl dodecyl dimethyl ammonium bromide; and combinations thereof. It will be appreciated by a person skilled in the art that mixtures of anionic and cationic emulsifiers may not be desirable.

In order to conduct the polymerization of the ethylenically unsaturated monomers, a free radical initiator is usually present. Both water soluble and oil soluble initiators can be used. Since the addition of certain initiators, such as redox initiators, can result in a strong exothermic reaction, it is generally desirable to add the initiator to the other ingredients immediately before the reaction is to be conducted. Examples of water-soluble initiators include ammonium peroxydisulfate, potassium peroxydisulfate and hydrogen peroxide. Examples of oil soluble initiators include t-butyl hydroperoxide, dilauryl peroxide, t-butyl perbenzoate and 2,2′-azobis(isobutyronitrile). Redox initiators such as ammonium peroxydisulfate/sodium metabisulfite or t-butylhydroperoxide/isoascorbic acid may be utilized herein.

Alternatively, the addition polymer in an aqueous medium can be prepared by a high stress technique such as microfluidization by use of a MICROFLUIDIZER® emulsifier which is available from Microfluidics Corporation in Newton, Mass. The MICROFLUIDIZER® high pressure impingement emulsifier is disclosed in U.S. Pat. No. 4,533,254, which is hereby incorporated by reference. The device consists of a high pressure (up to 1.4×10⁵ kPa (20,000 psi)) pump and an interaction chamber in which emulsification takes place. The pump forces the mixture of reactants in aqueous medium into the chamber where it is split into at least two streams which pass at very high velocity through at least two slits and collide, resulting in the particulation of the mixture into small particles. Generally, the reaction mixture is passed through the emulsifier once at a pressure of between 3.5×10⁴ and 1×10⁵ kPa (5,000 and 15,000 psi). Multiple passes can result in smaller average particle size and a narrower range for the particle size distribution. When using the aforesaid MICROFLUIDIZER® emulsifier, stress is applied by liquid-liquid impingement as has been described. However, it should be understood that, if desired, other modes of applying stress to the pre-emulsification mixture can be utilized so long as sufficient stress is applied to achieve the requisite particle size distribution, that is, such that after polymerization less than 20% of the polymer microparticles have a mean diameter greater than 5 microns. For example, one alternative manner of applying stress would be the use of ultrasonic energy.

Once the polymerization is complete, the resultant product is a stable dispersion of addition polymer in an aqueous medium. The aqueous medium, therefore, may be substantially free of water-soluble addition polymer. The resultant addition polymers are, of course, insoluble in the aqueous medium. As used herein, “substantially free” means that the aqueous medium contains no more than 30% by weight of dissolved addition polymer, such as no more than 15% by weight, based on the total weight of the addition polymer. By “stably dispersed” is meant that the polymer microparticles do not settle upon standing and essentially do not coagulate or flocculate during manufacturing or on standing.

The particle size of the addition polymer in the aqueous medium may be uniformly small, i.e., after polymerization less than 20% by weight of the addition polymer have a mean diameter which is greater than 5 microns, such as greater than 1 micron. Generally, the addition polymer has a mean diameter from 0.01 microns to 10 microns. The mean diameter of the addition polymer after polymerization may range from 0.05 microns to 0.5 microns. The particle size can be measured with a particle size analyzer such as the Coulter N4 instrument commercially available from Coulter. The instrument comes with detailed instructions for making the particle size measurement. However, briefly, a sample of the aqueous dispersion is diluted with water until the sample concentration falls within specified limits required by the instrument. The measurement time is 10 minutes.

The addition polymer may be present in the binder in amounts of at least 30% by weight, such as at least 40% by weight, such as at least 50% by weight, such as at least 65% by weight, such as at least 80% by weight, such as at least 90% by weight, such as at least 95% by weight, based on the total weight of the binder solids. The addition polymer may be present in the binder in amounts of 100% by weight, such as no more than 95% by weight, such as no more than 85% by weight, such as no more than 75% by weight, such as no more than 65% by weight, based on the total weight of the binder solids. The addition polymer may be present in the binder in amounts of 30% to 100% by weight, such as 30% to 95% by weight, such as 30% to 85% by weight, such as 30% to 75% by weight, such as 30% to 65% by weight, such as 40% to 100% by weight, such as 40% to 95% by weight, such as 40% to 85% by weight, such as 40% to 75% by weight, such as 40% to 65% by weight, such as 50% to 100% by weight, such as 50% to 95% by weight, such as 50% to 85% by weight, such as 50% to 75% by weight, such as 50% to 65% by weight, such as 65% to 100% by weight, such as 65% to 95% by weight, such as 65% to 85% by weight, such as 65% to 75% by weight, 80% to 100% by weight, such as 80% to 95% by weight, such as 80% to 85% by weight, 90% to 100% by weight, such as 90% to 95% by weight, 95% to 100% by weight, based on the total weight of the binder solids.

The addition polymer may be present in the slurry composition in an amount of at least 1% by weight, such as at least 2% by weight, such as at least 3% by weight, such as at least 4% by weight, based on the total solids weight of the slurry composition. The addition polymer may be present in an amount of no more than 10% by weight, such as no more than 8% by weight, such as no more than 5% by weight, such as no more than 4% by weight, such as no more than 3% by weight, such as no more than 2% by weight, such as no more than 1% by weight, based on the total solids weight of the slurry composition. The addition polymer may be present in an amount of 1% to 10% by weight, such as 1% to 8% by weight, such as 1% to 5% by weight, such as 1% to 4% by weight, such as 1% to 3% by weight, such as 1% to 2% by weight, such as 2% to 10% by weight, such as 2% to 8% by weight, such as 2% to 5% by weight, such as 2% to 4% by weight, such as 2% to 3% by weight, such as 3% to 10% by weight, such as 3% to 8% by weight, such as 3% to 5% by weight, such as 3% to 4% by weight, 4% to 5% by weight, based on the total solids weight of the slurry composition.

The addition polymer may be present in the slurry composition in an amount of at least 0.5% by weight, such as at least 1% by weight, such as at least 2% by weight, such as at least 3% by weight, such as at least 4% by weight, based on the total weight of the slurry composition. The addition polymer may be present in an amount of no more than 5% by weight, such as no more than 4% by weight, such as no more than 3% by weight, such as no more than 2% by weight, such as no more than 1% by weight, based on the total weight of the slurry composition. The addition polymer may be present in an amount of 0.5% to 5% by weight, such as 0.5% to 4% by weight, such as 0.5% to 3% by weight, such as 0.5% to 2% by weight, such as 0.5% to 1% by weight, such as 1% to 5% by weight, such as 1% to 4% by weight, such as 1% to 3% by weight, such as 1% to 2% by weight, such as 2% to 5% by weight, such as 2% to 4% by weight, such as 2% to 3% by weight, such as 3% to 5% by weight, such as 3% to 4% by weight, 4% to 5% by weight, based on the total weight of the slurry composition.

The slurry composition of the present disclosure further comprises an aqueous medium. As used herein, the term “aqueous medium” refers to a liquid medium comprising greater than 50% by weight water, based on the total weight of the aqueous medium. The aqueous medium may comprise water in an amount of at least 60% by weight, such as at least 70% by weight, such as at least 80% by weight, such as at least 90% by weight, based on the total weight of the aqueous medium. The aqueous medium may comprise water in an amount of 51% to 100% by weight, such as 60% to 100% by weight, such as 70% to 100% by weight, such as 80% to 100% by weight, such as 90% to 100% by weight, based on the total weight of the aqueous medium. The aqueous medium may be present in an amount of at least 30% by weight, such as at least 35% by weight, such as at least 40% by weight, such as at least 45.5% by weight, based on the total weight of the slurry composition. The aqueous medium may be present in an amount of no more than 60% by weight, such as no more than 54.5% by weight, based on the total weight of the slurry composition. The aqueous medium may be present in an amount of such as 30% to 60% by weight, such as 30% to 54.5% by weight, such as 35% to 60% by weight, such as 35% to 54.5% by weight, such as 40% to 60% by weight, such as 40% to 54.5% by weight, such as 45.5% to 60% by weight, such as 45.5% to 54.5% by weight, based on the total weight of the slurry composition.

The slurry composition may optionally further comprise an organic co-solvent. Any suitable organic solvent may be used. Non-limiting examples of the organic co-solvent include trialkyl phosphates, such as triethyl phosphate, Butyl CELLOSOLVE (2-butoxyethanol), Butyl CARBITOL (2-butoxyethanol), DOWANOL PnB (propylene glycol n-butyl ether), Hexyl CELLOSOLVE (Ethylene glycol monohexyl ether), or any combination thereof.

The organic co-solvent may optionally comprise a non-flammable, organic co-solvent. As used herein, the term “non-flammable, organic co-solvent” refers to organic solvents that have a flash point of at least 93° C. Non-limiting examples of the non-flammable co-solvent include trialkyl phosphates, such as triethyl phosphate, Butyl CARBITOL (2-butoxyethanol), or any combination thereof.

The organic co-solvent may be present, if at all, in an amount of at least 0.1% by weight, such as 0.25% by weight, such as at least 0.5% by weight, such as at least 1% by weight, based on the total weight of the aqueous medium. The organic co-solvent may be present, if at all, in an amount of no more than 20% by weight, such as no more than 15% by weight, such as no more than 10% by weight, such as no more than 5% by weight, such as no more than 4%, such as no more than 3% by weight, such as no more than 2% by weight, based on the total weight of the aqueous medium. The organic co-solvent may be present, if at all, in an amount of 0.1% to 20% by weight, such as 0.1% to 15% by weight, such as 0.1% to 10% by weight, 0.1% to 5% by weight, such as 0.1% to 4% by weight, such as 0.1% to 3% by weight, such as 0.1% to 2% by weight, such as 0.25% to 20% by weight, such as 0.25% to 15% by weight, such as 0.25% to 10% by weight, such as 0.25% to 5% by weight, such as 0.25% to 4% by weight, such as 0.25% to 3% by weight, such as 0.25% to 2% by weight, such as 0.5% to 20% by weight, such as 0.5% to 15% by weight, such as 0.5% to 10% by weight, such as 0.5% to 5% by weight, such as 0.5% to 3% by weight, such as 0.5% to 2% by weight, such as 1% to 20% by weight, such as 1% to 15% by weight, such as 1% to 10% by weight, such as 1% to 5% by weight, such as 1% to 4% by weight, such as 1% to 3% by weight, such as 1% to 2% by weight, based on the total weight of the aqueous medium.

The slurry composition may optionally further comprise styrene butadiene copolymer. As used herein, the term “styrene butadiene copolymer” refers to copolymers that comprise styrene (or a derivative thereof) and butadiene.

If present, the styrene butadiene copolymer may be present in the slurry composition in an amount of at least 0.5% by weight, such as at least 1% by weight, such as at least 2% by weight, such as at least 3% by weight, such as at least 4% by weight, based on the total solids weight of the slurry composition. The styrene butadiene copolymer may be present in an amount of no more than 5% by weight, such as no more than 4% by weight, such as no more than 3% by weight, such as no more than 2% by weight, such as no more than 1% by weight, based on the total solids weight of the slurry composition. The styrene butadiene copolymer may be present in an amount of 0.5% to 5% by weight, such as 0.5% to 4% by weight, such as 0.5% to 3% by weight, such as 0.5% to 2% by weight, such as 0.5% to 1% by weight, such as 1% to 5% by weight, such as 1% to 4% by weight, such as 1% to 3% by weight, such as 1% to 2% by weight, such as 2% to 5% by weight, such as 2% to 4% by weight, such as 2% to 3% by weight, such as 3% to 5% by weight, such as 3% to 4% by weight, 4% to 5% by weight, based on the total solids weight of the slurry composition.

Alternatively, the slurry composition may be substantially free, essentially free, or completely free of styrene butadiene copolymer. As used herein, the slurry composition is “substantially free” of styrene butadiene copolymer if styrene butadiene copolymer is present, if at all, in an amount of less than 0.5% by weight, based on the total solids weight of the slurry composition. As used herein, the slurry composition is “essentially free” of styrene butadiene copolymer if styrene butadiene copolymer is present, if at all, in an amount of less than 0.1% by weight, based on the total solids weight of the slurry composition. As used herein, the slurry composition is “completely free” of styrene butadiene copolymer if styrene butadiene copolymer is not present in the slurry composition, i.e., 0.0% by weight, based on the total solids weight of the slurry composition.

The slurry composition may optionally comprise a cellulose derivative. The cellulose derivative may be, for example, carboxymethylcellulose and salts thereof (CMC). CMC is a cellulosic ether in which a portion of the hydroxyl groups on the anhydroglucose rings are substituted with carboxymethyl groups. The degree of carboxymethyl substitution can range from 0.4-3. Since CMC is a long chain polymer, its viscosity in aqueous solutions depends on its molecular weight that can vary between 50,000 and 2,000,000 g/mol on a weight average basis. The carboxymethylcellulose may have a weight average molecular weight of at least 50,000 g/mol, such as at least 100,000 g/mol, or some cases, at least 200,000 g/mol, such as 50,000 to 1,000,000 g/mol, 100,000 to 500,000 g/mol, or 200,000 to 300,000 g/mol.

The cellulose derivative may be present in the binder in amounts of at least 30% by weight, such as at least 40% by weight, such as at least 50% by weight, such as at least 65% by weight, such as at least 80% by weight, such as at least 90% by weight, such as at least 95% by weight, based on the total weight of the binder solids. The cellulose derivative may be present in the binder in amounts of 100% by weight, such as no more than 95% by weight, such as no more than 85% by weight, such as no more than 75% by weight, such as no more than 65% by weight, based on the total weight of the binder solids. The cellulose derivative may be present in the binder in amounts of 30% to 100% by weight, such as 30% to 95% by weight, such as 30% to 85% by weight, such as 30% to 75% by weight, such as 30% to 65% by weight, such as 40% to 100% by weight, such as 40% to 95% by weight, such as 40% to 85% by weight, such as 40% to 75% by weight, such as 40% to 65% by weight, such as 50% to 100% by weight. such as 50% to 95% by weight, such as 50% to 85% by weight, such as 50% to 75% by weight, such as 50% to 65% by weight, such as 65% to 100% by weight, such as 65% to 95% by weight, such as 65% to 85% by weight, such as 65% to 75% by weight, 80% to 100% by weight, such as 80% to 95% by weight, such as 80% to 85% by weight, 90% to 100% by weight, such as 90% to 95% by weight, 95% to 100% by weight, based on the total weight of the binder solids.

The cellulose derivative may be present in the slurry composition in an amount of at least 1% by weight, such as at least 2% by weight, such as at least 3% by weight, such as at least 4% by weight, based on the total solids weight of the slurry composition. The cellulose derivative may be present in an amount of no more than 10% by weight, such as no more than 8% by weight, such as no more than 5% by weight, such as no more than 4% by weight, such as no more than 3% by weight, such as no more than 2% by weight, such as no more than 1% by weight, based on the total solids weight of the slurry composition. The cellulose derivative may be present in an amount of 1% to 10% by weight, such as 1% to 8% by weight, such as 1% to 5% by weight, such as 1% to 4% by weight, such as 1% to 3% by weight, such as 1% to 2% by weight, such as 2% to 10% by weight, such as 2% to 8% by weight, such as 2% to 5% by weight, such as 2% to 4% by weight, such as 2% to 3% by weight, such as 3% to 10% by weight, such as 3% to 8% by weight, such as 3% to 5% by weight, such as 3% to 4% by weight, 4% to 5% by weight, based on the total solids weight of the slurry composition.

The cellulose derivative may be present in the slurry composition in an amount of at least 0.5% by weight, such as at least 1% by weight, such as at least 2% by weight, such as at least 3% by weight, such as at least 4% by weight, based on the total weight of the slurry composition. The cellulose derivative may be present in an amount of no more than 5% by weight, such as no more than 4% by weight, such as no more than 3% by weight, such as no more than 2% by weight, such as no more than 1% by weight, based on the total weight of the slurry composition. The cellulose derivative may be present in an amount of 0.5% to 5% by weight, such as 0.5% to 4% by weight, such as 0.5% to 3% by weight, such as 0.5% to 2% by weight, such as 0.5% to 1% by weight, such as 1% to 5% by weight, such as 1% to 4% by weight, such as 1% to 3% by weight, such as 1% to 2% by weight, such as 2% to 5% by weight, such as 2% to 4% by weight, such as 2% to 3% by weight, such as 3% to 5% by weight, such as 3% to 4% by weight, 4% to 5% by weight, based on the total weight of the slurry composition.

The slurry composition may optionally further comprise a separately added crosslinking agent for reaction with the addition polymer. The crosslinking agent should be soluble or dispersible in the aqueous medium and be reactive with active hydrogen groups of the addition polymer, such as the carboxylic acid groups and the hydroxyl groups, if present. Non-limiting examples of suitable crosslinking agents include aminoplast resins, phenoplast resins, carbodiimides, polyoxazolines, polyaziridines, blocked polyisocyanates and polyepoxides.

Examples of aminoplast resins for use as a crosslinking agent are those which are formed by reacting a triazine such as melamine or benzoguanamine with formaldehyde. These reaction products contain reactive N-methylol groups. Usually, these reactive groups are etherified with methanol, ethanol, butanol including mixtures thereof to moderate their reactivity. For the chemistry preparation and use of aminoplast resins, see “The Chemistry and Applications of Amino Crosslinking Agents or Aminoplast”, Vol. V. Part II, page 21 ff., edited by Dr. Oldring; John Wiley & Sons/Cita Technology Limited, London, 1998. These resins are commercially available under the trademark MAPRENAL® such as MAPRENAL MF980 and under the trademark CYMEL® such as CYMEL 303 and CYMEL 1128, available from Cytec Industries.

Blocked polyisocyanate crosslinking agents are typically diisocyanates such as toluene diisocyanate, 1,6-hexamethylene diisocyanate and isophorone diisocyanate including isocyanato dimers and trimers thereof in which the isocyanate groups are reacted (“blocked”) with a material such as epsilon-caprolactone and methylethyl ketoxime. At curing temperatures, the blocking agents unblock exposing isocyanate functionality that is reactive with the hydroxyl functionality associated with the (meth)acrylic polymer. Blocked polyisocyanate crosslinking agents are commercially available from Covestro as DESMODUR BL.

Phenoplast resins are formed by the condensation of an aldehyde and a phenol. Suitable aldehydes include formaldehyde and acetaldehyde. Methylene-releasing and aldehyde-releasing agents, such as paraformaldehyde and hexamethylene tetramine, may also be utilized as the aldehyde agent. Various phenols may be used, such as phenol itself, a cresol, or a substituted phenol in which a hydrocarbon radical having either a straight chain, a branched chain or a cyclic structure is substituted for a hydrogen in the aromatic ring. Mixtures of phenols may also be employed. Some specific examples of suitable phenols are p-phenylphenol, p-tert-butylphenol, p-tert-amylphenol, cyclopentylphenol and unsaturated hydrocarbon-substituted phenols, such as the monobutenyl phenols containing a butenyl group in ortho, meta or para position, and where the double bond occurs in various positions in the hydrocarbon chain.

Carbodiimide crosslinking agents may be in monomeric or polymeric form, or a mixture thereof. Carbodiimide crosslinking agents refer to compounds having the following structure:

R—N═C═N—R′

wherein R and R′ may each individually comprise an aliphatic, aromatic, alkylaromatic, carboxylic, or heterocyclic group. Examples of commercially available carbodiimide crosslinking agents include, for example, those sold under the trade name CARBODILITE available from Nisshinbo Chemical Inc., such as CARBODILITE V-02-L2, CARBODILITE SV-02, CARBODILITE E-02, CARBODILITE SW-12G, CARBODILITE V-10 and CARBODILITE E-05.

Examples of polyepoxide crosslinking agents are epoxy-containing (meth)acrylic polymers such as those prepared from glycidyl methacrylate copolymerized with other vinyl monomers, polyglycidyl ethers of polyhydric phenols such as the diglycidyl ether of bisphenol A; and cycloaliphatic polyepoxides such as 3,4-epoxycyclohexylmethyl-3,4-epoxycyclohexane carboxylate and bis(3,4-epoxy-6-methylcyclohexyl-methyl) adipate.

The separately added crosslinker may be present in the slurry composition in amounts of up to 25% by weight, such as 0.1% to 25% by weight, such as 0.1% to 15% by weight, such as 1% to 25% by weight, such as 1% to 15% by weight, the % by weight being based on the total weight of the binder solids.

The binder solids may be present in the slurry composition in amounts of at least 1% by weight, such as at least 1.5% by weight, such as at least 2% by weight, such as at least 3% by weight, such as at least 4% by weight, based on the total solids weight of the slurry. The binder solids may be present in the slurry composition in amounts of no more than 10% by weight, such as no more than 7.5% by weight, such as no more than 5% by weight, such as no more than 4% by weight, such as no more than 3% by weight, based on the total solids weight of the slurry. The binder solids may be present in the slurry composition in amounts of 1% to 10% by weight, such as 1% to 7.5% by weight, such as 1% to 5% by weight, such as 1% to 4% by weight, such as 1% to 3% by weight, such as 1.5% to 10% by weight, such as 1.5% to 7.5% by weight, such as 1.5% to 5% by weight, such as 1.5% to 4% by weight, such as 1.5% to 3% by weight, such as 2% to 10% by weight, such as 2% to 7.5% by weight, such as 2% to 5% by weight, such as 2% to 4% by weight, such as 2% to 3% by weight, such as 3% to 10% by weight, such as 3% to 7.5% by weight, such as 3% to 5% by weight, such as 3% to 4% by weight, such as 4% to 10% by weight, such as 4% to 7.5% by weight, such as 4% to 5% by weight, based on the total solids weight of the slurry.

The slurry composition further comprises negative electrode active material. The material constituting the negative electrode active material contained in the slurry is not particularly limited and a suitable material can be selected according to the type of an electrical storage device of interest. The negative electrode active material may comprise graphite, silicon, silicon oxide, or combinations thereof.

The negative electrode active material may be present in the slurry composition in an amount of at least 90% by weight, such as 91% by weight, such as at least 92% by weight, such as 93% by weight, such as 95% by weight, such as 97% by weight, such as 98% by weight, based on the total solids weight of the slurry composition. The negative electrode active material may be present in the slurry composition in an amount of no more than 99% by weight, such as no more than 97% by weight, such as no more than 95% by weight, based on the total solids weight of the slurry composition. The negative electrode active material may be present in the slurry composition in an amount of 90% to 99% by weight, such as 90% by 97% by weight, such as 90% to 95% by weight, such as 91% to 99% by weight, such as 91% to 97% by weight, such as 91% to 95% by weight, such as 92% to 99% by weight, such as 92% to 97% by weight, such as 92% to 95% by weight, such as 93% to 99% by weight, such as 93% to 97% by weight, such as 93% to 95% by weight, such as 95% to 99% by weight, such as 95% to 97% by weight, such as 97% to 99% by weight, such as 98% to 99% by weight, based on the total solids weight of the slurry composition.

The negative electrode active material may be present in the slurry composition in an amount of at least 45% by weight, such as 47% by weight, such as at least 49% by weight, based on the total weight of the slurry composition. The negative electrode active material may be present in the slurry composition in an amount of no more than 49.5% by weight, such as no more than 48% by weight, such as no more than 46% by weight, based on the total weight of the slurry composition. The negative electrode active material may be present in the slurry composition in an amount of 45% to 49.5% by weight, such as 45% to 48% by weight, such as 45% to 46% by weight, such as 47% to 49.5% by weight, such as 47% to 48% by weight, such as 49% to 49.5% by weight, based on the total weight of the slurry composition.

The slurry composition of the present disclosure may optionally further comprise an electrically conductive agent. The electrically conductive agent is a material that has a higher electrical conductivity than graphite. Non-limiting examples of electrically conductive agents include carbonaceous materials such as, activated carbon, carbon black such as acetylene black and furnace black, graphene, carbon nanotubes, including single-walled carbon nanotubes and/or multi-walled carbon nanotubes, carbon fibers, fullerene, and combinations thereof.

The electrically conductive agent may be present, if at all, in the slurry in amounts of at least 0.01% by weight, such as at least 0.05% by weight, such as at least 0.1% by weight, such as at least 0.5% by weight, such as at least 1% by weight, such as at least 1.5% by weight, such as at least 2% by weight, based on the total solids weight of the slurry. The electrically conductive agent may be present in the slurry in amounts of no more than 10% by weight, such as no more than 7.5% by weight, such as no more than 5% by weight, such as no more than 4% by weight, such as no more than 3% by weight, such as no more than 2.5% by weight, such as no more than 2% by weight, such as no more than 1.5% by weight, based on the total solids weight of the slurry. The electrically conductive agent may be present in the slurry in amounts of 0.01% to 10% by weight, such as 0.01% to 7.5% by weight, such as 0.01% to 5% by weight, such as 0.01% to 4% by weight, such as 0.01% to 3% by weight, such as 0.01% to 2.5% by weight, such as 0.01% to 2% by weight, such as 0.01% to 1.5% by weight, such as 0.05% to 10% by weight, such as 0.05% to 7.5% by weight, such as 0.05% to 5% by weight, such as 0.05% to 4% by weight, such as 0.05% to 3% by weight, such as 0.05% to 2.5% by weight, such as 0.05% to 2% by weight, such as 0.05% to 1.5% by weight, such as 0.1% to 10% by weight, such as 0.1% to 7.5% by weight, such as 0.1% to 5% by weight, such as 0.1% to 4% by weight, such as 0.1% to 3% by weight, such as 0.1% to 2.5% by weight, such as 0.1% to 2% by weight, such as 0.1% to 1.5% by weight, such as 0.5% to 10% by weight, such as 0.5% to 7.5% by weight, such as 0.5% to 5% by weight, such as 0.5% to 4% by weight, such as 0.5% to 3% by weight, such as 0.5% to 2.5% by weight, such as 0.5% to 2% by weight, such as 0.5% to 1.5% by weight, such as 1% to 10% by weight, such as 1% to 7.5% by weight, such as 1% to 5% by weight, such as 1% to 4% by weight, such as 1% to 3% by weight, such as 1% to 2.5% by weight, such as 1% to 2% by weight, such as 1% to 1.5% by weight, such as 1.5% to 10% by weight, such as 1.5% to 7.5% by weight, such as 1.5% to 5% by weight, such as 1.5% to 4% by weight, such as 1.5% to 3% by weight, such as 1.5% to 2.5% by weight, such as 1.5% to 2% by weight, such as 2% to 10% by weight, such as 2% to 7.5% by weight, such as 2% to 5% by weight, such as 2% to 4% by weight, such as 2% to 3% by weight, such as 2% to 2.5% by weight, based on the total solids weight of the slurry.

The negative electrode slurry composition comprising the aqueous medium, negative electrode active material, binder dispersion (which may include a separately added crosslinking agent), and optional ingredients, such as an electrically conductive material, may be prepared by combining the ingredients to form the slurry. These substances can be mixed together by agitation with a known means such as a stirrer, bead mill or high-pressure homogenizer.

As for mixing and agitation for the manufacture of the electrode slurry composition, a mixer capable of stirring these components to such an extent that satisfactory dispersion conditions are met should be selected. The degree of dispersion can be measured with a particle gauge and mixing and dispersion are preferably carried out to ensure that agglomerates of 100 microns or more are not present. Examples of the mixers which meets this condition include ball mill, sand mill, pigment disperser, grinding machine, extruder, rotor stator, pug mill, ultrasonic disperser, homogenizer, planetary mixer, Hobart mixer, and combinations thereof.

The present disclosure is also directed to a negative electrode comprising (a) an electrical current collector; and (b) a film formed on the electrical current collector, wherein the film comprises (1) a binder comprising an addition polymer comprising (i) 0.1% to 15% by weight of a (meth)acrylic acid; (ii) 0.1% to 25% by weight of an ethylenically unsaturated monomer comprising a hydroxyl functional group; (iii) 30% to 90% by weight of an alkyl ester of (meth)acrylic acid; and (iv) 0.1% to 50% by weight of a vinyl aromatic compound, the % by weight based on the total weight of the addition polymer; and (2) a negative electrode active material. The film may be deposited from the negative electrode slurry composition described above. The negative electrode may be manufactured by applying the above-described slurry composition to the surface of the current collector to form a coating film, and subsequently drying and/or curing the coating film. The coating film may have a thickness of at least 1 micron, such as 1 to 500 microns (μm), such as 150 to 500 μm, such as 200 to 500 μm, or thicker. The coating film may comprise a cross-linked coating, and the film may further comprise the residue of a crosslinking agent. The current collector may comprise a conductive material, and the conductive material may comprise a metal such as iron, copper, aluminum, nickel, and alloys thereof, as well as stainless steel. For example, the current collector may comprise aluminum or copper in the form of a mesh, sheet or foil. Although the shape and thickness of the current collector are not particularly limited, the current collector may have a thickness of about 0.001 to 0.5 mm, such as a mesh, sheet or foil having a thickness of about 0.001 to 0.5 mm.

In addition, the current collector may be pretreated with a pretreatment composition prior to depositing the slurry composition. As used herein, the term “pretreatment composition” refers to a composition that upon contact with the current collector, reacts with and chemically alters the current collector surface and binds to it to form a protective layer. The pretreatment composition may be a pretreatment composition comprising a group IIIB and/or IVB metal. As used herein, the term “group IIIB and/or IVB metal” refers to an element that is in group IIIB or group IVB of the CAS Periodic Table of the Elements as is shown, for example, in the Handbook of Chemistry and Physics, 63^{rd} edition (1983). Where applicable, the metal themselves may be used, however, a group IIIB and/or IVB metal compound may also be used. As used herein, the term “group IIIB and/or IVB metal compound” refers to compounds that include at least one element that is in group IIIB or group IVB of the CAS Periodic Table of the Elements. Suitable pretreatment compositions and methods for pretreating the current collector are described in U.S. Pat. No. 9,273,399 at col. 4, line 60 to col. 10, line 26, the cited portion of which is incorporated herein by reference. The pretreatment composition may be used to treat current collectors used to produce positive electrodes or negative electrodes.

The method of applying the slurry composition to the current collector is not particularly limited. The slurry composition may be applied by doctor blade coating, dip coating, reverse roll coating, direct roll coating, gravure coating, extrusion coating, immersion or brushing. Although the application quantity of the slurry composition is not particularly limited, the thickness of the coating formed after the aqueous medium is removed per side of the current collector may be at least 1 micron, such as 1 to 500 microns (μm), such as 150 to 500 μm, such as 200 to 500 μm, or thicker. For example, the thickness of the coating formed may be 200 microns or thicker per side.

Drying and/or crosslinking the coating film after application, if applicable, can be done, for example, by heating at elevated temperature, such as at least 40° C., such as at least 50° C., such as at least 60° C., such as 40-145° C., such as 50-120° C., such as 60-100° C. The time of heating will depend somewhat on the temperature. Generally, higher temperatures require less time for curing. Typically, curing times are for at least 5 minutes, such as 5 to 60 minutes. The temperature and time should be sufficient such that the addition polymer in the cured film is crosslinked (if applicable), that is, covalent bonds are formed between co-reactive groups on the addition polymer polymer chain, such as carboxylic acid groups and hydroxyl groups and the N-methylol and/or the N-methylol ether groups of an aminoplast, isocyanato groups of a blocked polyisocyanate crosslinking agent. Other methods of drying the coating film include ambient temperature drying, microwave drying and infrared drying, and other methods of curing the coating film include e-beam curing and UV curing.

The dried film may comprise residual organic co-solvent in an amount of less than 2,000 ppm, or less than 1,000 ppm, or less than 200 ppm, or less than 50 ppm. The residual organic co-solvent may be present in an amount of at least 1 ppm, such as at least 20 ppm, such as at least 50 ppm. The residual organic co-solvent may be present in an amount of 1 to 2,000 ppm, such as 1 to 1,000 ppm, such as 1 to 200 ppm, such as 1 to 50 ppm, such as 20 to 2,000 ppm, such as 20 to 1,000 ppm, such as 20 to 200 ppm, such as 20 to 50 ppm, such as 50 to 2,000 ppm, such as 50 to 1,000 ppm, such as 50 to 200 ppm.

During discharge of a lithium ion electrical storage device, lithium ions may be released from the negative electrode and carry the current to the positive electrode. This process may include the process known as deintercalation. During charging, the lithium ions migrate from the electrochemically active material in the positive electrode to the negative electrode where they become embedded in the electrochemically active material present in the negative electrode. This process may include the process known as intercalation.

The binder of the present disclosure may allow for production of negative electrodes that include graphite as the negative electrode active material having good charge density, for example, the electrodes may have areal loadings, thicknesses, and areal charge density as indicated in the table below.

| Areal Loading | | Areal Density |
|---|---|---|
| (mg/cm²) | Thickness (um) | (mAh/cm²) |
| 10 | 80-90 | 3-3.5 |
| 15 | 120-140 | 4.5-5 |
| 22 | 180-200 | 7-7.5 |
| 25 | 220-250 | 8-9 |
| 40 | 320-360 | 12-14 |

The binder of the present disclosure may allow for production of negative electrodes that include Si-graphite composite active material (95% graphite and 5% Si by weight) as the negative electrode active material having good charge density, for example, the electrodes may have areal loadings, thicknesses, and areal charge density as indicated in the table below.

| Areal Loading | | Areal Density |
|---|---|---|
| (mg/cm²) | Thickness (um) | (mAh/cm²) |
| 3-5 | 30-40 | 3-4 |
| 6-10 | 80-100 | 5-6 |

The film on the electrical current collector of the electrode of the present disclosure comprising the addition polymer-containing binder, negative electrode active material, and the other optional components such as the electrically conductive agent, cellulose derivative and/or the crosslinking agent, may have an adhesion to the current collector at least 5% higher than a comparative film that does not include the addition polymer comprising a silicon-containing functional group comprising at least one alkoxy substituent, such as at least 8% higher, such as at least 10% higher, such as at least 12% higher, such as at least 15% higher, as measured by the PEEL STRENGTH TEST METHOD. As used herein, a comparative film means a film applied from a slurry composition having the same negative electrode active material, aqueous medium, and, if present, electrically conductive material, cellulose derivative, and/or crosslinking agent, but lacks the addition polymer-containing binder.

The PEEL STRENGTH TEST METHOD may be performed as follows: Strips of the coated electrode may be cut 0.5 inches and affixed to an untreated aluminum panel using 3M 444 double sided tape. The adhesive strength of two strips of coated electrode may be evaluated using a 90-degree peel test on MARK-10 ESM303 at a speed of 50 mm/min.

The film on the electrical current collector of the electrode of the present disclosure comprising the addition polymer-containing binder, negative electrode active material, and the other optional components such as the electrically conductive agent, cellulose derivative and/or the crosslinking agent, may have surprisingly good flexibility, and the film may maintain good flexibility at high coating loadings. For example, the film at up to 25 mg/cm² loading may maintain integrity after a mandrel bend of ⅛″, as performed according to ASTM D 522-88.

The negative electrodes of the present disclosure may also possess good capacity retention during the life of an electrical storage device, and the good capacity retention may be retained at high coating loadings.

The present disclosure is also directed to an electrical storage device. An electrical storage device according to the present disclosure can be manufactured by using the above negative electrode prepared from the negative electrode slurry composition of the present disclosure. The electrical storage device may further comprise a positive electrode, an electrolyte, and a polymer separator. The positive electrode comprises a positive electrode active material, non-limiting examples of which include active material may comprise a material capable of incorporating lithium (including incorporation through lithium intercalation/deintercalation), a material capable of lithium conversion, or combinations thereof. Non-limiting examples of electrochemically active materials capable of incorporating lithium include LiCoO₂, LiNiO₂, LiFePO₄, LiCoPO₄, LiMnO₂, LiMn₂O₄, Li(NiMnCo)O₂, Li(NiCoAl)O₂, carbon-coated LiFePO₄, and combinations thereof. Non-limiting examples of materials capable of lithium conversion include sulfur, LiO₂, FeF₂ and FeF₃, Si, aluminum, tin, SnCo, Fe₃O₄, and combinations thereof. Electrical storage devices according to the present disclosure include a cell, a battery, a battery pack, a secondary battery, a capacitor, and a supercapacitor.

The electrical storage device includes an electrolytic solution and can be manufactured by using parts such as a separator in accordance with a commonly used method. As a more specific manufacturing method, a negative electrode and a positive electrode are assembled together with a separator there between, the resulting assembly is rolled or bent in accordance with the shape of a battery and put into a battery container, an electrolytic solution is injected into the battery container, and the battery container is sealed up. The shape of the battery may be like a coin, button or sheet, cylindrical, square or flat.

The electrolytic solution may be liquid or gel, and an electrolytic solution which can serve effectively as a battery may be selected from among known electrolytic solutions which are used in electrical storage devices in accordance with the types of a negative electrode active material and a positive electrode active material. The electrolytic solution may be a solution containing an electrolyte dissolved in a suitable solvent. The electrolyte may be conventionally known lithium salt for lithium ion secondary batteries. Examples of the lithium salt include LiClO₄, LiBF₄, LiPF₆, LiCF₃CO₂, LiAsF₆, LiSbF₆, LiB₁₀Cl₁₀, LiAlCl₄, LiCl, LiBr, LiB(C₂H₅)₄, LiB(C₆H₅)₄, LiCF₃SO₃, LiCH₃SO₃, LiC₄F₉SO₃, Li(CF₃SO₂)₂N, LiB₄CH₃SO₃Li and CF₃SO₃Li. The solvent for dissolving the above electrolyte is not particularly limited and examples thereof include organic carbonate compounds such as propylene carbonate, ethylene carbonate, butylene carbonate, dimethyl carbonate, methyl ethyl carbonate and diethyl carbonate; lactone compounds such as γ-butyl lactone; ether compounds such as trimethoxymethane, 1,2-dimethoxyethane, diethyl ether, 2-ethoxyethane, tetrahydrofuran and 2-methyltetrahydrofuran; and sulfoxide compounds such as dimethyl sulfoxide. The concentration of the electrolyte in the electrolytic solution may be 0.5 to 3.0 mole/L, such as 0.7 to 2.0 mole/L.

As used herein, the term “polymer” refers broadly to oligomers and both homopolymers and copolymers. The term “resin” is used interchangeably with “polymer”.

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C₁-C₂ substituted acrylic acids, such as methacrylic acid, 2-ethylacrylic acid, etc., and their C₁-C₄ alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer. The term “(meth)acrylic polymer” refers to polymers prepared from one or more (meth)acrylic monomers.

As used herein molecular weights are determined by gel permeation chromatography using a polystyrene standard. Unless otherwise indicated molecular weights are on a weight average basis. As used herein, the term “weight average molecular weight” or “(M_{w})” means the weight average molecular weight (M_{w}) as determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. UV detector; 254 nm, solvent: unstabilised THF, retention time marker: toluene, sample concentration: 2 mg/ml). As used herein, the term “number average molecular weight” or “(Mₙ)” means the number average molecular weight (Mₙ) as determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. UV detector; 254 nm, solvent: unstabilised THF, retention time marker: toluene, sample concentration: 2 mg/ml).

The term “glass transition temperature” as used herein is a theoretical value, being the glass transition temperature as calculated by the method of Fox on the basis of monomer composition of the monomer charge according to T. G. Fox, Bull. Am. Phys. Soc. (Ser. II) 1, 123 (1956) and J. Brandrup, E. H. Immergut, Polymer Handbook 3^{rd} edition, John Wiley, New York, 1989.

As used herein, unless otherwise defined, the term substantially free means that the component is present, if at all, in an amount of less than 5% by weight, based on the total weight of the slurry composition.

As used herein, unless otherwise defined, the term essentially free means that the component is present, if at all, in an amount of less than 1% by weight, based on the total weight of the slurry composition.

As used herein, unless otherwise defined, the term completely free means that the component is not present in the slurry composition, i.e., 0.00% by weight, based on the total weight of the slurry composition.

As used herein, the term “total solids” refers to the non-volatile components of the slurry composition of the present disclosure and specifically excludes the aqueous medium.

As used herein, the term “consists essentially of” includes the recited material or steps and those that do not materially affect the basic and novel characteristics of the claimed disclosure.

As used herein, the term “consists of” excludes any element, step or ingredient not recited.

For purposes of the detailed description, it is to be understood that the disclosure may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about.” even if the term does not expressly appear. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “a” negative electrode active material, “an” addition polymer, and “an” electrically conductive agent, a combination (i.e., a plurality) of these components can be used. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described. Although various embodiments of the disclosure have been described in terms of “comprising”, embodiments consisting essentially of or consisting of are also within the scope of the present disclosure.

As used herein, the terms “on,” “onto,” “applied on,” “applied onto,” “formed on,” “deposited on,” “deposited onto,” mean formed, overlaid, deposited, or provided on but not necessarily in contact with the surface. For example, a composition “deposited onto” a substrate does not preclude the presence of one or more other intervening coating layers of the same or different composition located between the electrodepositable coating composition and the substrate.

Whereas specific embodiments of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof. Each of the characteristics and examples described herein, and combinations thereof, may be said to be encompassed by the present disclosure.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Synthetic Procedures for Experimental Electrode Binders

Synthesis of Example Binder A: A four neck round bottom flask equipped with a thermometer, mechanical stirrer, condenser, nitrogen inlet adapter, and a heating mantle. To the flask was added 382.5 grams of deionized water and 7.93 grams of surfactant (Adeka Reasoap SR-1025). The reactor was heated to a set point of 80° C. under a nitrogen blanket. A pre-emulsion solution was prepared by mixing 139 grams of deionized water, 11.8 grams of Adeka Reasoap SR-1025, 246.5 grams of butyl acrylate, 110 grams of styrene, 32.9 grams of 2-hydroxyethyl methacrylate, and 7.2 grams of methacrylic acid. An initiator solution was prepared by mixing 51.8 grams of deionized water and 3.17 grams of ammonium persulfate. Once the reactor was at 80° C., 30% of the initiator solution was added over 5 minutes via addition funnel. The reactor was held at temperature for 5 minutes, then 5% of the pre-emulsion solution was added over 5 minutes via addition funnel. The reactor was held at temperature for 30 minutes. The remainder of the initiator solution was added over 5 minutes via addition funnel. The reactor was held at temperature for 5 minutes, then the remainder of the pre-emulsion solution was added over 180 minutes via addition funnel. After the feed was complete, the reactor was held at 80° C. for 60 minutes. After the hold, the reactor was cooled to 50° C. then a solution of 51 grams of deionized water and 21 grams of 2-butoxyethanol was added over 10 minutes via addition funnel. The reactor was held at 50° C. for 10 minutes then the binder solution was poured through a 10-micron bag into a suitable container. The binder had a measured solids content of 37.5%.

Synthesis of Example Binder B: A four neck round bottom flask equipped with a thermometer, mechanical stirrer, condenser, nitrogen inlet adapter, and a heating mantle. To the flask was added 382.5 grams of deionized water and 7.93 grams of surfactant (Adeka Reasoap SR-1025). The reactor was heated to a set point of 80° C. under a nitrogen blanket. A pre-emulsion solution was prepared by mixing 135.7 grams of deionized water, 11.8 grams of Adeka Reasoap SR-1025, 6.88 grams of methoxy poly(ethylene glycol) methacrylate [50% aqueous solution, 2,000 MW], 243 grams of butyl acrylate, 110 grams of styrene, 32.9 grams of 2-hydroxyethyl methacrylate, and 7.2 grams of methacrylic acid. An initiator solution was prepared by mixing 51.8 grams of deionized water and 3.17 grams of ammonium persulfate. Once the reactor was at 80° C., 30% of the initiator solution was added over 5 minutes via addition funnel. The reactor was held at temperature for 5 minutes, then 5% of the pre-emulsion solution was added over 5 minutes via addition funnel. The reactor was held at temperature for 30 minutes. The remainder of the initiator solution was added over 5 minutes via addition funnel. The reactor was held at temperature for 5 minutes, then the remainder of the pre-emulsion solution was added over 180 minutes via addition funnel. After the feed was complete, the reactor was held at 80° C. for 60 minutes. After the hold, the reactor was cooled to 50° C. then a solution of 51 grams of deionized water and 21 grams of 2-butoxyethanol was added over 10 minutes via addition funnel. The reactor was held at 50° C. for 10 minutes then the binder solution was poured through a 10-micron bag into a suitable container. The binder had a measured solids content of 38.5%.

### General Preparation of Negative Electrode Waterborne Slurries

Procedure A—Comparative CMC/SBR control slurry formulations: To a plastic cup was added carboxymethylcellulose (“CMC”, available from Nippon, DS=0.7, M_{w}=350,000, 2% solids) and, if present in the formula, conductive carbon (TIMCAL C-NERGY™ SUPER C65). The materials were mixed in a centrifugal mixer at 2000 rpm with 4 very high-density zirconium oxide milling beads (Glenmills, 5 mm) for 3 minutes. Graphite was then added along with deionized water and the slurry was mixed in a centrifugal mixer at 2000 rpm for 1 minute. The slurry was diluted with additional deionized water and mixed in a centrifugal mixer at 2000 rpm for 2 minutes. Finally, styrene butadiene rubber (“SBR”, 40% solids, Zeon BM-451B) was added, then was mixed in a centrifugal mixer at 2000 rpm for 30 seconds. The fully formulated slurry had a % solids ranging between 40-50% based on total weight of the composition.

Procedure B—Experimental electrode slurry formulations: To a plastic cup was added carboxymethylcellulose (“CMC”, available from Nippon, DS=0.7, M_{w}=350,000, 2% solids) and, if present in the formula, conductive carbon (TIMCAL C-NERGY™ SUPER C65). The mixture was mixed in a centrifugal mixer at 2000 rpm with 4 very high-density zirconium oxide milling beads (Glenmills, 5 mm) for 3 minutes. Graphite was then added along with deionized water and the mixture was agitated in a centrifugal mixer at 2000 rpm for 1 minute. The slurry was diluted with additional deionized water and mixed in a centrifugal mixer at 2000 rpm for 2 minutes. Finally, Example Binder A or Example Binder B was added, then the slurry was mixed in a centrifugal mixer at 2000 rpm for 30 seconds. The fully formulated slurry had a % solids ranging between 40-50% based on total weight of the composition.

### General Preparation of Negative Electrodes

Method A—preparation of negative electrode films on copper: Electrode films were cast from slurry compositions using a draw down bar on a draw down table onto copper foil. The target coating weight was 5-40 mg/cm² for each negative electrode. This wet coating was dried at 55° C. for two minutes followed by 100° C. for two minutes. After drying, the electrode films were pressed to a porosity of 30-35%.

### Example 1

Comparative Composition 1: This slurry was prepared according to Procedure A and used OSG 23 (a graphite material available from Gelon). The ratio of the components of the slurry were 97% graphite to 1.5% CMC to 1.5% SBR, the % being by weight and based on the total weight of the solids. A film was cast with according to Method A with a final coating weight of 5.0 mg/cm². The adhesion of the negative electrode was measured according to the PEEL STRENGTH TEST METHOD described above with the results in the table below.

Experimental Composition 1: This slurry was prepared according to Procedure B and used OSG 23 (a graphite material available from Gelon). The ratio of the components of the slurry were 97% graphite to 1.5% CMC to 1.5% Binder B, the % being by weight and based on the total weight of the solids. A film was cast with according to Method A with a final coating weight of 5.0 mg/cm². The adhesion of the negative electrode was measured according to the PEEL STRENGTH TEST METHOD described above with the results in the table below.

| | Comparative | Experimental |
|---|---|---|
| | Composition 1 | Composition 1 |
| Peel Strength (N/m) | 45 | 65 |

The results of the adhesion testing show an improvement in adhesion for Experimental Composition 1 that includes Binder B compared to Comparative Composition 1 that includes SBR.

### Example 2

Comparative Composition 2: This slurry was prepared according to procedure A and used Superior Graphite SLC1520T (a graphite material available from Superior Graphite). The ratio of the components of the slurry were 95% graphite to 1.0% conductive carbon to 2.0% CMC to 2.0% SBR, the % being by weight and based on the total weight of the solids. A negative electrode film was cast according to Method A with a final coating weight of 5.0 mg/cm².

Experimental Composition 2: This slurry was prepared according to procedure B and used Superior Graphite SLC1520T (a graphite material available from Superior Graphite). The ratio of the components of the slurry were 95% graphite to 1.0% conductive carbon to 2.0% CMC to 2.0% Binder B, the % being by weight and based on the total weight of the solids. A negative electrode film was cast according to Method A with a final coating weight of 5.0 mg/cm².

Coin half cells were assembled using the negative electrodes based on Comparative Composition 2 and Experimental Composition 2. Cells were built in triplicate for each composition with lithium metal used as the counter electrode. Cells were formed and cycled at C/10 for 5 cycles and then were cycled at C/3 for 25 cycles. The results of the electrochemical testing are in the table below and demonstrate that Experimental Composition that includes Binder B shows an improved initial capacity and capacity retention compared to Comparative Composition 2 that includes SBR.

| | Comparative | Experimental |
|---|---|---|
| | Composition 2 - | Composition 2 - |
| | Discharge Capacity | Discharge Capacity |
| | (mAh/g) | (mAh/g) |
| Cycle 0 (C/10) | 304 | 352 |
| Cycle 1 (C/10) | 316 | 352 |
| Cycle 2 (C/10) | 319 | 353 |
| Cycle 3 (C/10) | 323 | 351 |
| Cycle 4 (C/10) | 326 | 353 |
| Cycle 5 (C/3) | 270 | 325 |
| Cycle 30 (C/3) | 159 | 265 |
| | Comparative | Experimental |
| | Composition 2 | Composition 2 |
| Capacity retention¹ at | 59% | 82% |
| C/3 (% retention) | | |

¹The reported value is a ratio of discharge capacity after cycle 5 to the discharge capacity after cycle 30

### Example 3

Thicker electrode films are known to suffer from larger internal stresses during processing and subsequent handling and are particularly prone to cracking. Electrode binders comprised of CMC and SBR also suffer from poor processing properties at higher film thickness and larger coating weights. To address this issue, a co-solvent was added to the slurry to change the subsequent film properties. Electrodes comprised of CMC and Example Binder B as the binder components were prepared from waterborne slurries including various co-solvents.

Preparation of anode slurries with co-solvents and negative electrode films. All of the slurries described in the following table were prepared in a manner consistent with Procedure B except the liquid medium was a mixture of 1 part co-solvent (identified in the table below) to 9 parts water by weight. Each slurry had a solids content of 46% with a ratio of 95% Superior Graphite SLC1520T (a graphite material available from Superior Graphite) to 1.5% CMC to 2% Binder B to 0.5% C65 carbon to 1.0% carbon nanotubes (available from Tuball), the % being by weight and based on total weight of the solids. Each slurry was used to cast a negative electrode film consistent with Method A. The target coating weight was at least 20 mg/cm². The adhesion was evaluated using the PEEL STRENGTH METHOD and each film was inspected for the presence of cracks. The use of a co-solvent improved film quality (no cracks), but reduced adhesion as presented in the table below.

| | | Adhesion | |
|---|---|---|---|
| | Co-solvent | (N/m) | Film Cracking? |
| Comparative | None | 21 | Yes |
| Composition 3 | | | |
| (No solvent) | | | |
| Composition 3A | Isopropyl alcohol | 8 | No |
| Composition 3B | Butyl CELLOSOLVE | 16 | No |
| Composition 3C | Butyl CARBITOL | 10 | No |
| Composition 3D | DOWANOL PnB | 5 | No |
| Composition 3E | Hexyl CELLOSOLVE | 12 | No |
| Composition 3F | Triethyl Phosphate | 15 | No |

### Example 4

Evaluation of co-solvent level on adhesion. All of the slurries described in the following table were prepared in a manner consistent with Procedure B except the liquid medium composition was varied using different ratios of water and triethyl phosphate as co-solvent. Each slurry had a solids content of 43% with a ratio of 94% Superior Graphite SLC1520T (a graphite material available from Superior Graphite) to 1.5% CMC to 3.5% Binder B to 1.0% C65 conductive carbon, the % being by weight and based on total weight of the solids. Each slurry was used to cast a negative electrode film consistent with Method A. The target coating weight was at least 20 mg/cm². The adhesion was evaluated using the PEEL STRENGTH METHOD and each film was inspected for the presence of cracks. The following table shows the results.

| | Weight Ratio of Co- | Adhesion | |
|---|---|---|---|
| | solvent to Water | (N/m) | Film Cracking? |
| Comparative | 0:1 | 37 | Yes |
| Composition 3 | | | |
| (No solvent) | | | |
| Composition 4A | 1:100 | 37 | No |
| Composition 4B | 1:50 | 30 | No |
| Composition 4C | 1:20 | 26 | No |

The result demonstrate that the co-solvent can be added to prevent cracking at various levels.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. A negative electrode waterborne slurry composition comprising
a binder comprising an addition polymer comprising:
(a) 0.1% to 15% by weight of constitutional units comprising the residue of an alpha, beta-ethylenically unsaturated carboxylic acid;
(b) 0.1% to 25% by weight of constitutional units comprising the residue of an ethylenically unsaturated monomer comprising a hydroxyl functional group;
(c) 30% to 90% by weight of constitutional units comprising the residue of an alkyl ester of (meth)acrylic acid; and
(d) 0.1% to 50% by weight of constitutional units comprising the residue of a vinyl aromatic compound, the % by weight based on the total weight of the addition polymer;
a negative electrode active material; and
an aqueous medium.

2. The negative electrode waterborne slurry composition of claim 1, wherein the addition polymer further comprises 0.1% to 10% by weight of constitutional units comprising the residue of a methoxy(poly(alkyleneglycol)) (meth)acrylate.

3. The negative electrode waterborne slurry composition of claim 1, wherein the addition polymer has a weight average molecular weight of 5,000 g/mol to 1,000,000 g/mol.

4. The negative electrode waterborne slurry composition of claim 1, wherein the addition polymer has a theoretical glass transition temperature of less than 50° C.

5. The negative electrode waterborne slurry composition of claim 1, wherein the binder further comprises cellulose or a cellulose derivative.

6. The negative electrode waterborne slurry composition of claim 1, wherein the binder further comprises a styrene-butadiene copolymer.

7. The negative electrode waterborne slurry composition of claim 1, wherein the binder is substantially free of styrene-butadiene polymer.

8. The negative electrode waterborne slurry composition of claim 1, wherein the binder further comprises a crosslinking agent.

9. The negative electrode waterborne slurry composition of claim 1, wherein the negative electrode active material comprises graphite, silicon, silicon oxide, or combinations thereof.

10. The negative electrode waterborne slurry composition of claim 1, further comprising a conductive additive comprising conductive carbon, carbon nanotubes, graphene, or any combination thereof.

11. The negative electrode waterborne slurry composition of claim 1 comprising:
1% to 10% by weight of the binder; and
90% to 99% by weight of the negative electrode active material, based on the total solids weight of the composition.

12. The negative electrode waterborne slurry composition of claim 1 comprising:
0.5% to 5% by weight of the binder;
45% to 49.5% by weight of the negative electrode active material; and
45.5% to 54.5% by weight of the aqueous medium, based on the total weight of the composition.

13. The negative electrode waterborne slurry composition of claim 1 comprising:
0.5% to 5% by weight of the binder; and
0.5% to 5% by weight of the cellulose or cellulose derivative, based on the total solids weight of the composition.

14. The negative electrode waterborne slurry composition of claim 1 further comprising an organic co-solvent present in an amount of 0.1% to 20% by weight, based on the total weight of the aqueous medium.

15. (canceled)

16. The negative electrode waterborne slurry composition of claim 14, wherein the organic co-solvent comprises a non-flammable, organic co-solvent having a flash point of at least 93° C.

17. (canceled)

18. A negative electrode comprising:
(a) an electrical current collector; and
(b) a film formed on the electrical current collector, wherein the film comprises:
(1) a binder comprising an addition polymer comprising:
(i) 0.1% to 15% by weight of constitutional units comprising the residue of an alpha, beta-ethylenically unsaturated carboxylic acid;
(ii) 0.1% to 25% by weight of constitutional units comprising the residue of an ethylenically unsaturated monomer comprising a hydroxyl functional group;
(iii) 30% to 90% by weight of constitutional units comprising the residue of an alkyl ester of (meth)acrylic acid; and
(iv) 0.1% to 50% by weight of constitutional units comprising the residue of a vinyl aromatic compound, the % by weight based on the total weight of the addition polymer; and
(2) a negative electrode active material.

19. (canceled)

20. The electrode of claim 18, wherein the film comprises residual organic co-solvent in an amount of less than 2,000 ppm.

21. An electrical storage device comprising:
(a) the negative electrode of claim 18;
(b) a positive electrode;
(c) an electrolyte; and
(d) a polymer separator.

22. The electrical storage device of claim 21, wherein the electrolyte (c) comprises a lithium salt dissolved in a solvent comprising an organic carbonate.

23. (canceled)

24. The electrical storage device of claim 21, wherein the electrical storage device comprises a cell, a battery pack, a secondary battery, a capacitor, or a supercapacitor.
